(19) United States
(12) Patent Application Publication
(10) Pub. No.: US 2015/0128815 A1
(43) Pub. Date: May 14, 2015

(54) Coffee Brewing Device

(71) Applicant: Uni-Splendor Corp., Tainan (TW)

(72) Inventor: Yu-Yuan Lin, Tainan (TW)

(21) Appl. No.: 14/078,621

(22) Filed: Nov. 13, 2013

(51) Int. Cl. A47J 31/36

(52) U.S. Cl. CPC A47J 31/36
USPC 99/302 P

(57) ABSTRACT

A coffee brewing device provides a coffee heating mechanism for brewing coffee and/or related beverages and is advantageously characterized in that: a pressure check valve and an S-shaped tube are disposed in sequence between a water outlet end of a water tank and a heating pipe connected thereto; a pump and an air escape valve are disposed at appropriate points of a hot water chamber which stores boiled water heated to a predetermined temperature; during its heating process, unboiled water in the S-shaped tube is returned to the water tank to therefore confine the unboiled water to the water tank; and, after the unboiled water has been heated up and then introduced into the hot water chamber, the boiled water is pressurized appropriately by the pump and introduced into a container for beverages to be brewed.

### BACKGROUND OF THE INVENTION

1. Technical Field

The present invention provides a coffee brewing device which provides a coffee heating mechanism for brewing coffee and/or related beverages and is advantageously characterized in that: a pressure check valve and an S-shaped tube are disposed in sequence between a water outlet end of a water tank and a heating pipe connected thereto; a pump and an air escape valve are disposed at appropriate points of a hot water chamber which stores boiled water heated to a predetermined temperature; during its heating process, unboiled water in the S-shaped tube is returned to the water tank to therefore confine the unboiled water to the water tank; and, after the unboiled water has been heated up and then introduced into the hot water chamber, the boiled water is pressurized appropriately by the pump and introduced into a container for beverages to be brewed.

2. Description of Related Art

Conventional coffee brewers whereby coffee is brewed manually and immediately before drinking manifest diversity in form. One of them entails conveying unboiled water from a water tank to a heating pipe, heating the unboiled water until it reaches a required temperature, and introducing boiled water into a hot water chamber such that, in response to a button-pushing act performed by a user for starting a coffee brewing process, the boiled water is introduced into a container in which coffee grounds and/or required ingredients are available and beverages are to be brewed.

The aforesaid conventional coffee brewers do fulfill their anticipated purpose of heating water to provide boiled water at a predetermined temperature and thereby brew coffee and/or related beverages. The present invention improves on the prior art by providing a coffee brewing device whereby not only is the boiled water at a predetermined temperature appropriately pressurized by an external driving means and thus introduced into a container for beverages to be brewed, but the unboiled water is also prevented from entering the hot water chamber.

### BRIEF SUMMARY OF THE INVENTION

It is an objective of the present invention to provide a coffee brewing device effective in operating a conventional coffee heating mechanism in a novel manner to heat unboiled water at a predetermined temperature and then introduce the resultant boiled water into a hot water chamber to brew coffee or related beverages, such that the coffee brewing device is advantageously characterized in that: a pressure check valve and an S-shaped tube are disposed in sequence between a water outlet end of a water tank and a heating pipe connected thereto; a pump and an air escape valve are disposed at appropriate points of a hot water chamber which stores boiled water heated to a predetermined temperature; during its heating process, unboiled water in the S-shaped tube is returned to the water tank to therefore confine the unboiled water to the water tank; and, after the unboiled water has been heated up and then introduced into the hot water chamber, the boiled water is pressurized appropriately by the pump and introduced into a container for beverages to be brewed.

In order to achieve the above and other objectives, the present invention provides a coffee brewing device which provides a coffee heating mechanism for brewing coffee and/or related beverages and is advantageously characterized in that: a pressure check valve and an S-shaped tube are disposed in sequence between a water outlet end of a water tank and a heating pipe connected thereto; a pump and an air escape valve are disposed at appropriate points of a hot water chamber which stores boiled water heated to a predetermined temperature; as soon as the unboiled water is introduced into the hot water chamber, the air escape valve is open, such that redundant steam is discharged; the pump is turned on to produce an air pressure in order to begin a coffee pre-boiling process, wherein, at this point in time, the air escape valve is closed; the unboiled water which remains in the S-shaped tube is returned to the water tank under the air pressure, and the pressure check valve is turned off; and, after the unboiled water in the heating pipe has been heated up and thus turned into the boiled water at a predetermined temperature and then introduced into the hot water chamber, the boiled water is pressurized appropriately by the pump and introduced into the container for beverages to be brewed.

### BRIEF DESCRIPTION OF THE SEVERAL VIEWS OF THE DRAWINGS

FIG. 1 is a front view of a coffee brewing device (not operating) according to the present invention;

FIG. 2 is a schematic view of the coffee brewing device operating during a water feeding process according to the present invention; and

FIG. 3 is a schematic view of the coffee brewing device operating during a coffee boiling and steeping process according to the present invention.

### DETAILED DESCRIPTION OF THE INVENTION

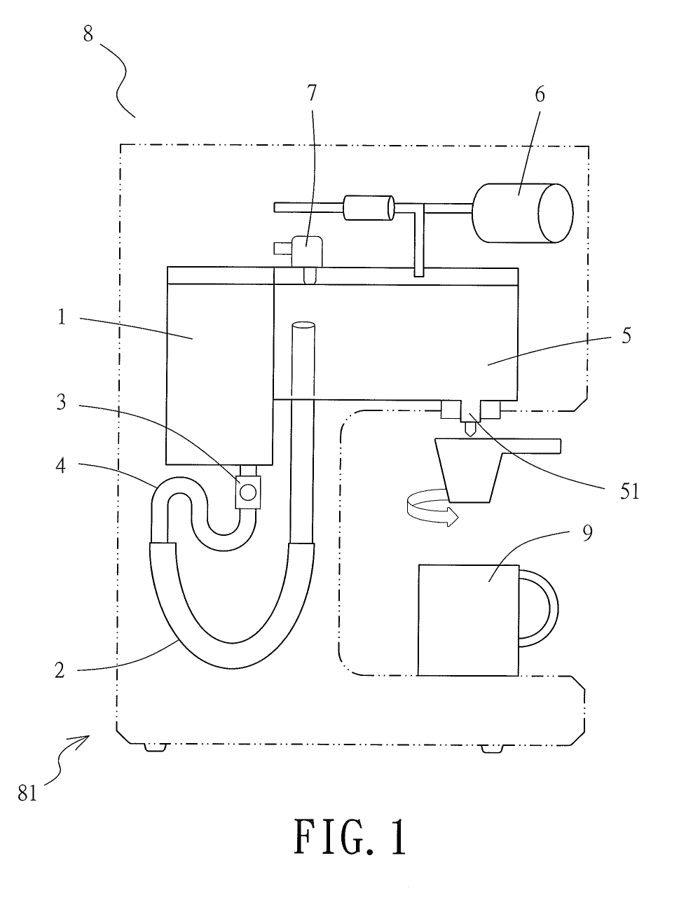

Referring to FIG. 1, a coffee brewing device of the present invention provides a heating mechanism 81 of a coffee brewer 8 for brewing coffee and/or related beverages and comprises a water tank 1, a heating pipe 2, and a hot water chamber 5. The water tank 1 holds unboiled water. The heating pipe 2 is disposed peripherally with a heating unit and connected to a water outlet end of the water tank 1. A pressure check valve 3 and an S-shaped tube 4 are disposed in sequence between the water outlet end of the water tank 1 and the heating pipe 2 connected thereto. The hot water chamber 5 is adapted to store boiled water heated to a predetermined temperature and connected to the other end of the heating pipe 2. A water outlet 51 is disposed at a predetermined point of the hot water chamber 5 such that, in response to a button-pushing act performed by a user for starting a coffee brewing process, the boiled water is introduced into a container 9 for beverages to be brewed. A pump 6 and an air escape valve 7 are disposed at appropriate points of the hot water chamber 5 which stores the boiled water heated to a predetermined temperature.

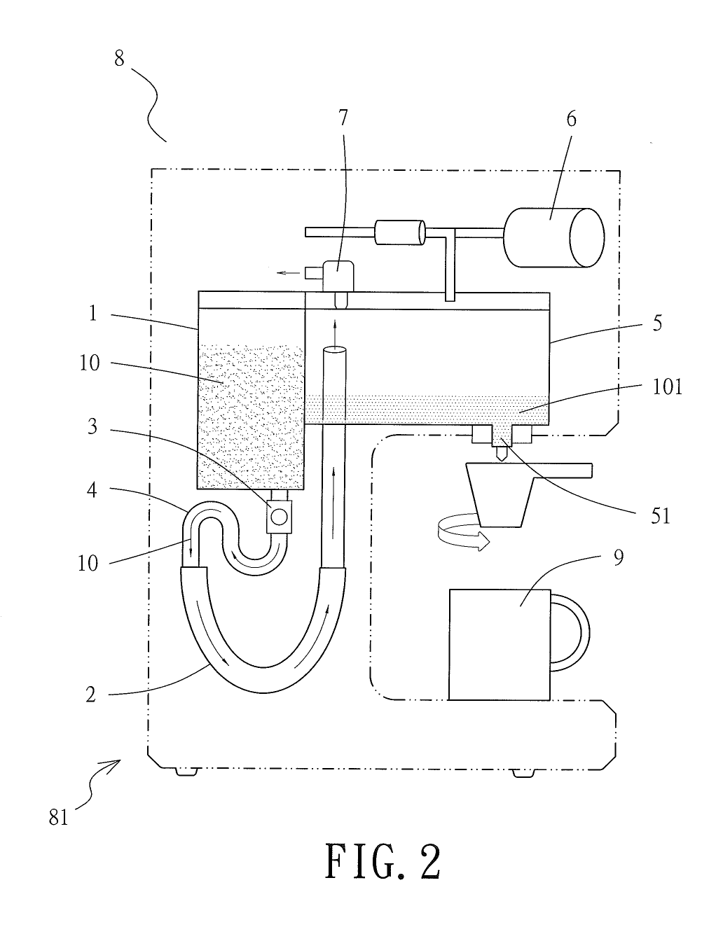

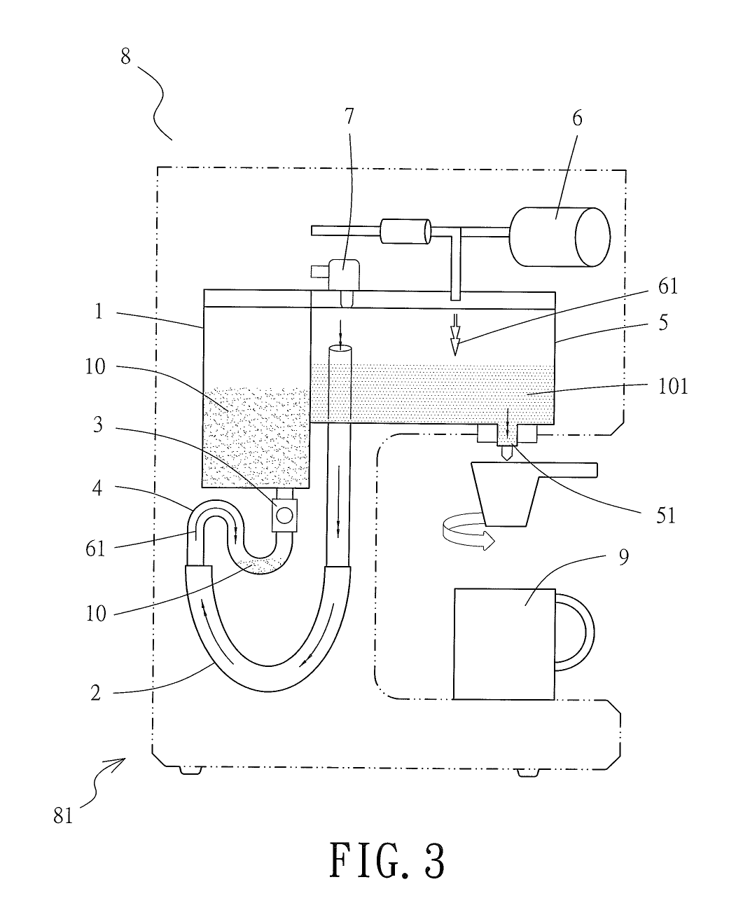

Referring to FIG. 2, the heating process performed to brew coffee and/or related beverages by means of the heating mechanism 81 of the coffee brewer 8 comprises the steps as follows: unboiled water 10 is conveyed from the water tank 1 to the heating pipe 2 via the pressure check valve 3 and the S-shaped tube 4, wherein, at this point in time, the air escape valve 7 disposed at a predetermined point of the hot water chamber 5 is open, such that redundant steam is discharged from the heating pipe 2; the pump 6 disposed at a predetermined point of the hot water chamber 5 is turned on to produce an appropriate air pressure 61 in order to begin a coffee pre-boiling process (as shown in FIG. 3, wherein, at this point in time, the air escape valve 7 disposed beside the hot water chamber 5 is closed); the unboiled water 10 which remains in the S-shaped tube 4 is returned to the water tank 1 under the air pressure 61, and the pressure check valve 3 is turned off so as to confine the unboiled water 10 to the water tank 1; and, after the unboiled water 10 in the heating pipe 2 has been heated up and thus turned into boiled water 101 at a predetermined temperature and then introduced into the hot water chamber 5, the boiled water 101 is pressurized appropriately by the pump 6 disposed at a predetermined point of the hot water chamber 5 and introduced into the container 9 for beverages to be brewed. Hence, during the process of boiling coffee and/or related hot beverages by means of the heating mechanism 81 of the coffee brewer 8, the boiled water 101 is pressurized appropriately to prevent the unboiled water 10 from entering the hot water chamber 5 and help introduce the boiled water 101 at the predetermined temperature into the container 9 for beverages to be brewed.

What is claimed is:

1. A coffee brewing device, providing a coffee heating mechanism for brewing coffee and/or related beverages, the coffee brewing device comprising:
a water tank for holding unboiled water;
a heating pipe disposed peripherally with a heating unit and connected to a water outlet end of the water tank; and
a hot water chamber adapted to store boiled water heated to a predetermined temperature and connected to another end of the heating pipe, wherein a water outlet is disposed at a predetermined point of the hot water chamber such that, in response to a button-pushing act performed by a user for starting a coffee brewing process, the boiled water is introduced into a container for beverages to be brewed,
wherein a pressure check valve and an S-shaped tube are disposed in sequence between the water outlet end of the water tank and the heating pipe connected thereto, wherein a pump and an air escape valve are disposed at appropriate points of the hot water chamber which stores the boiled water heated to a predetermined temperature,
wherein, as soon as the unboiled water is introduced into the hot water chamber, the air escape valve is open, such that redundant steam is discharged, wherein the pump is turned on to produce an air pressure in order to begin a coffee pre-boiling process, wherein, at this point in time, the air escape valve is closed, wherein the unboiled water which remains in the S-shaped tube is returned to the water tank under the air pressure, and the pressure check valve is turned off, wherein, after the unboiled water in the heating pipe has been heated up and thus turned into the boiled water at a predetermined temperature and then introduced into the hot water chamber, the boiled water is pressurized appropriately by the pump and introduced into the container for beverages to be brewed.
